(19) United States
(12) Patent Application Publication
(10) Pub. No.: US 2005/0158158 A1
(43) Pub. Date: Jul. 21, 2005

(54) Method for railroad transport and apparatus for loading and unloading trains

(76) Inventor: Guido Porta, Arenzano (IT)

Correspondence Address: DAVID A. GUERRA, 933 OLANDER WAY SOUTH, SUITE 3, SOUTH PASADENA, FL, 33707, US

(21) Appl. No.: 10/504,943

(22) PCT Filed: Feb. 20, 2003
(86) PCT No.: PCT/EP03/01771

(30) Foreign Application Priority Data
Feb. 20, 2002 (IT) MI2002A000337

(51) Int. Cl. B65F 9/00

(52) U.S. Cl. 414/392

(57) ABSTRACT

The method according to the invention includes the following steps: a first transport by truck to the nearest station provided with a specialized terminal (1); placing of the load unit (2), constituted by a standard container, on the ground or on a transfer system (4), which in turn feeds an automated loading platform which, by means of remote-controlled servo-assisted systems, loads the load unit (2) onto a railcar (3) with systems for horizontal translational motion.

The present invention relates to a method for railroad transport and to an apparatus for loading and unloading trains.

According to the prior art, a user not linked up to the railroad line has various options for transporting goods by rail.

A first option is to request from the railroad company special railcars for the intended type of goods; then request them to be made available at an enabled station; transport the load to the station by truck, unloading and reloading the goods at the station, thus keeping the railcar inactive for the entire duration of the loading operation. The same procedure must be used at destination.

Another possibility is to request that the provided railcar be carried on a trailer from the nearest enabled station, load the railcar directly, keeping it inactive for the entire duration of the loading operation, and then return it to the initial station; a similar procedure must be used at destination.

In both cases, the loaded railcar must be hitched to the first usable train, often waiting as long as several days.

After covering the first leg by rail, often the railcar must be processed in switching centers, losing a few days of time in rerouting operations.

Essentially, the advantage of using correctly the useful volume or capacity of the railcar entail a series of problems of other kinds that make the system lose its competitiveness.

In particular:
costs for road transport of the load or for transporting the railcar by trailer to the nearest station;
costs for transfer from truck to railcar;
costs for damage to the goods during the additional handling;
cost for railcar inactivity during the loading/unloading operations;
costs for guiding the railcar into the loading station;
costs related to switching operations during the trip;
costs for maneuvers for composing the train and in the subsequent switching centers;
costs generated on the client, related to the extension of the return times;
costs for railcar inactivity owing to the long return times of the railcar;
system costs due to complaint management, return verification requests, et cetera.

In addition to the above, there are the natural transport costs when the railcar is part of the composition of the train along the intended line.

The aim of the present invention is to provide a method an apparatus that overcome the drawbacks of the cited prior art.

An object of the invention is to provide a system that ensures operating simplicity, rapid execution, and flexibility in use.

A further object of the invention is to provide a system that is highly safe and ensures interoperability with conventional systems.

A further object of the invention is to provide a system that can be implemented together with other transportation systems, such as ships, trucks and trains, both for incoming and outgoing cargo.

A further object is to provide a system that allows modest investments and a containment of operating costs.

A further object is to provide a system that operates efficiently in all weather conditions.

A further object is to allow to operate in combination both more complex facilities and simpler facilities.

A further object is to be able to perform loading and unloading operations on electrified tracks without particular operating limitations.

This aim, these objects and others that will become better apparent hereinafter are achieved by a railroad transport method and by an apparatus for loading unloading trains, as claimed in the accompanying claims.

Characteristics and advantages of the invention will become apparent from the following description of preferred but not exclusive embodiments, illustrated only by way of non-limitative example in the accompanying drawings, wherein:

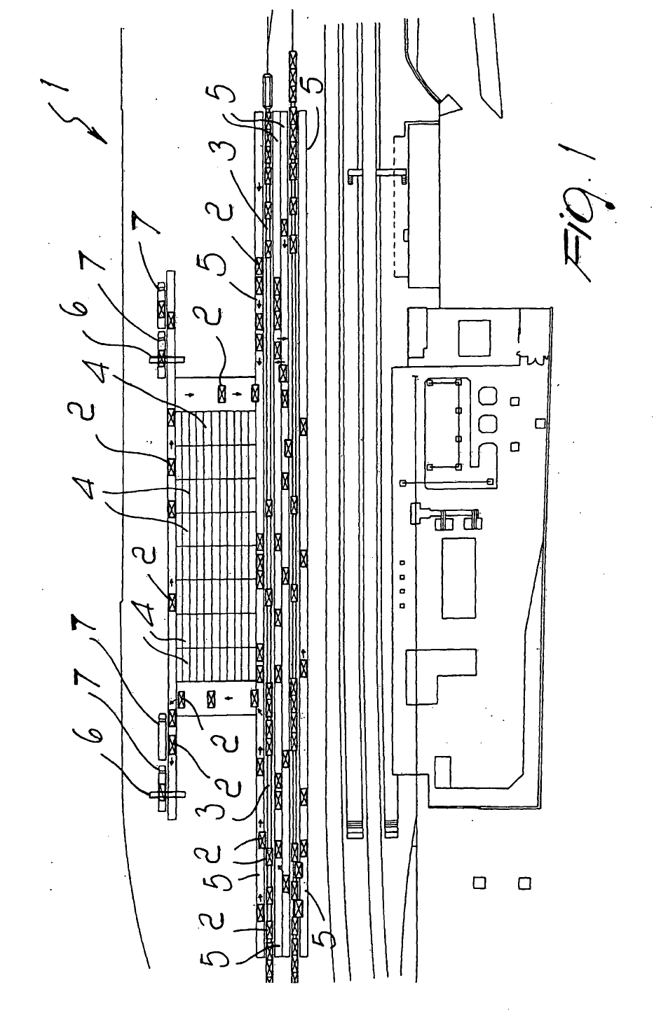

FIG. 1 is a plan view of a possible configuration of the loading and unloading terminal according to the invention;

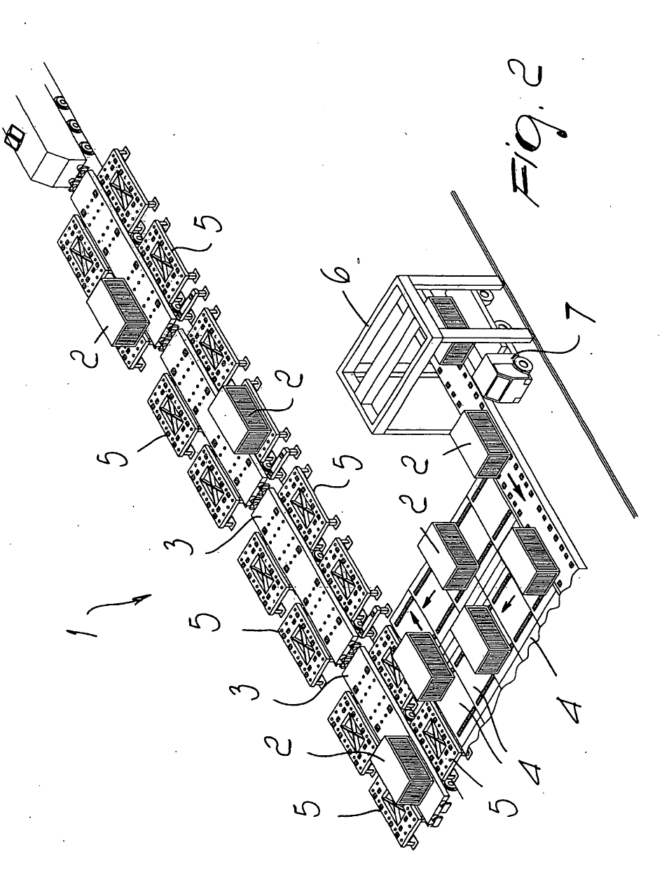

FIG. 2 is a perspective view of the terminal of FIG. 1;

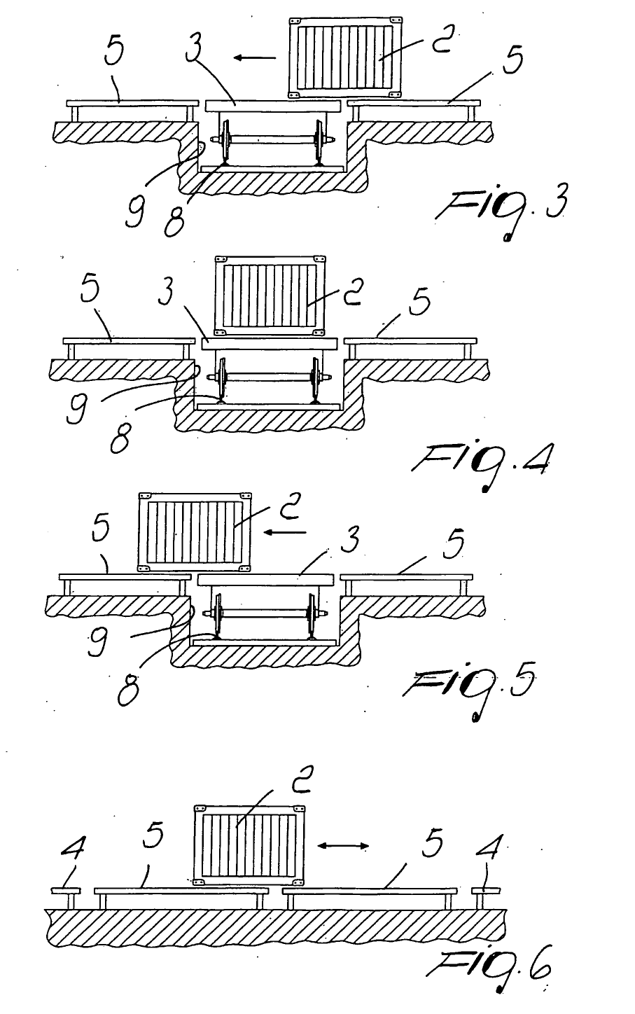

FIGS. 3 to 6 are schematic front elevation views of the handling of a load unit on the transfer lanes and on the railcars;

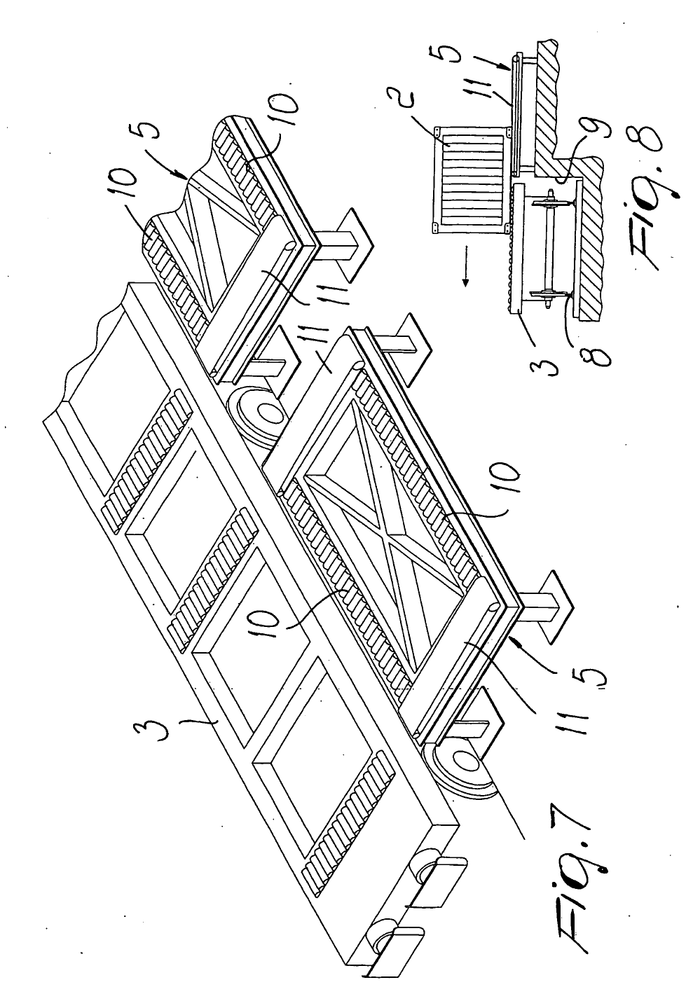

FIG. 7 is a more detailed perspective view of a sector that constitutes the transfer lanes and of a railcar;

FIG. 8 is a schematic front elevation view of the transfer of a load unit from the sector of FIG. 7 to a railcar;

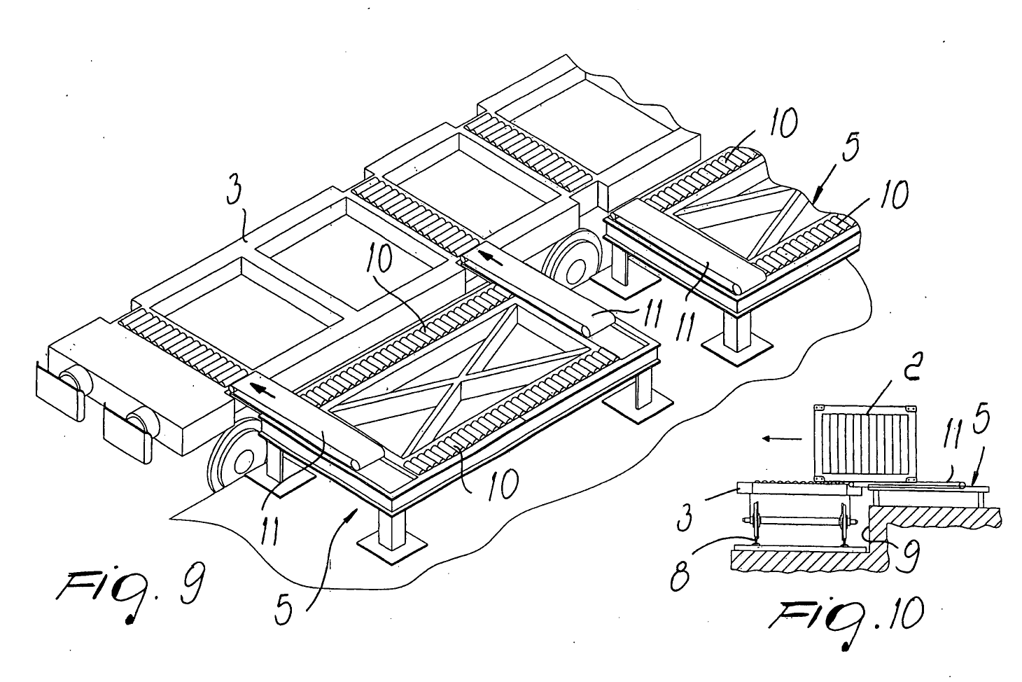

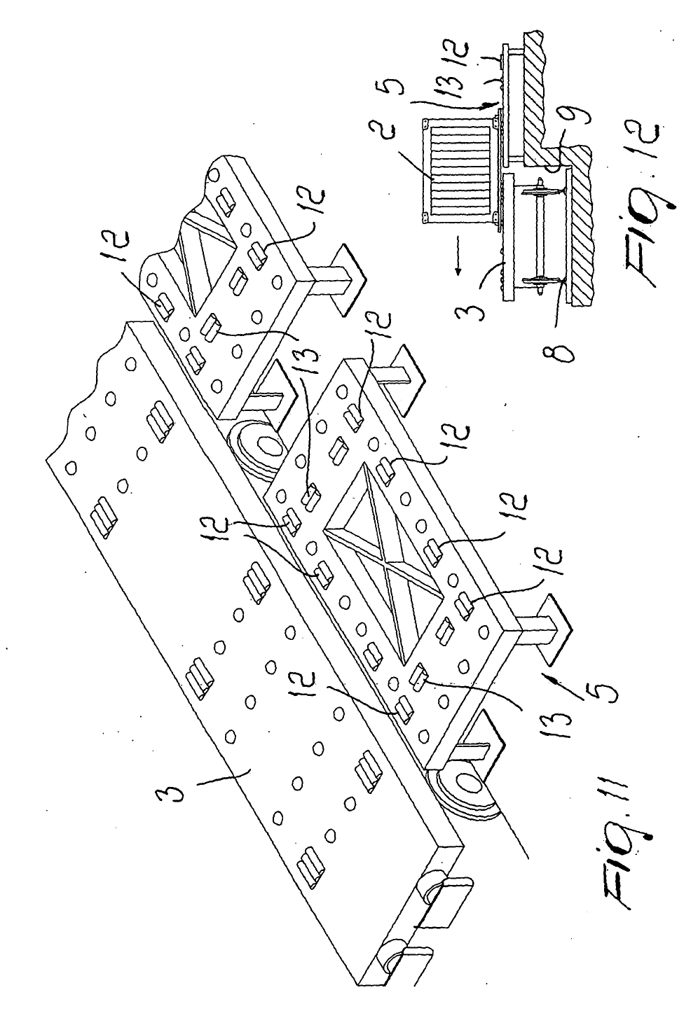

FIGS. 9 and 10 are views, similar to FIGS. 7 and 8 respectively, of the movement of the lateral conveyor belts during the loading of a load unit onto the railcar;

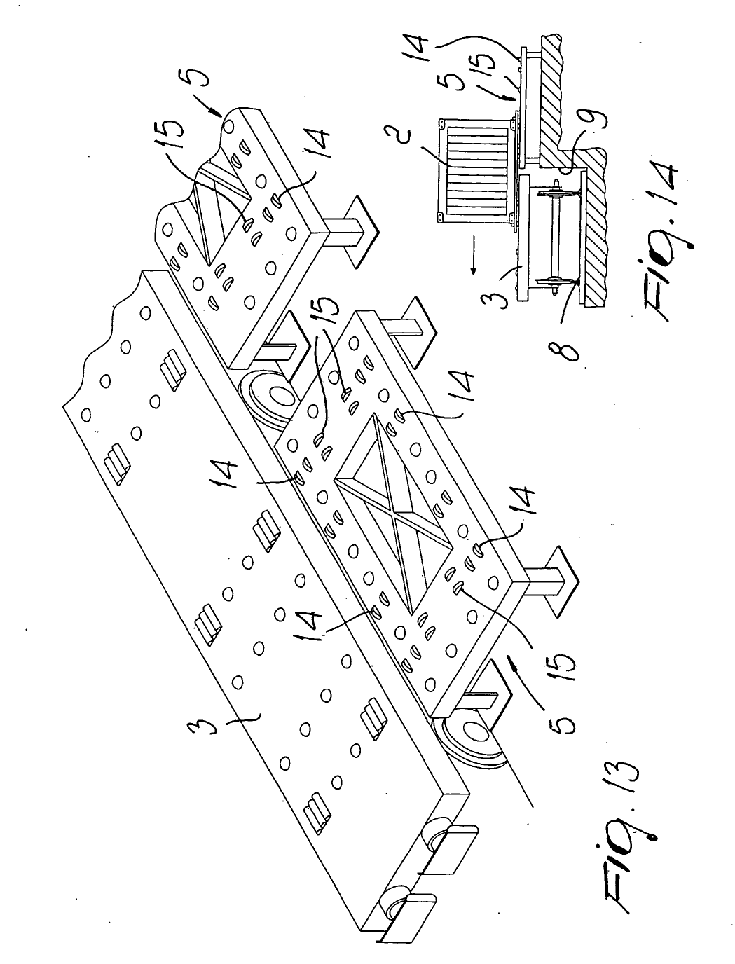

FIG. 11 is a more detailed perspective view of a sector that constitutes the transfer lanes and of a railcar, according to a further aspect of the invention;

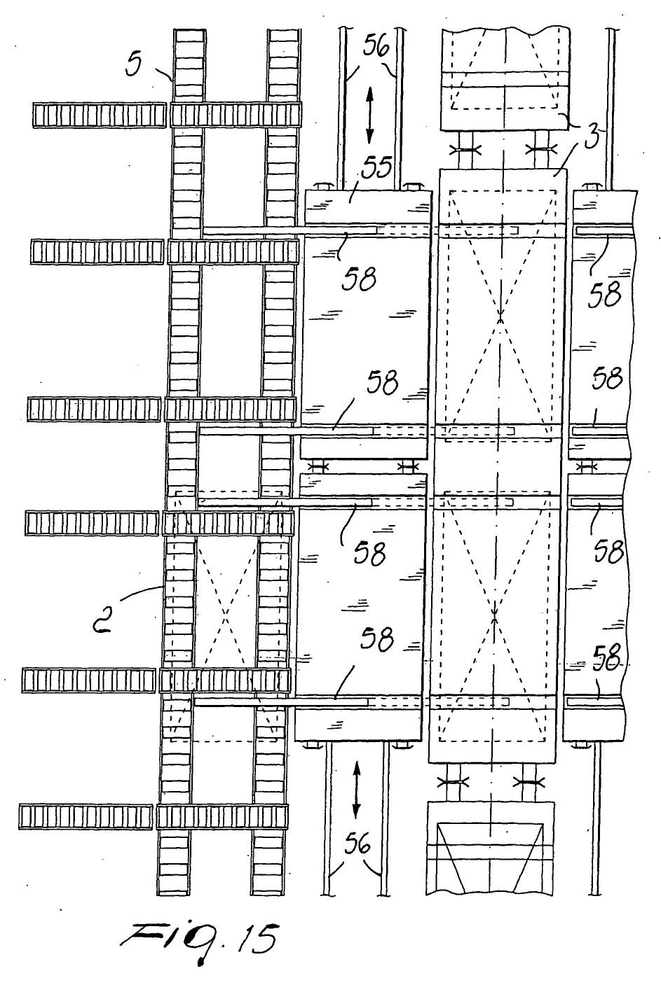

FIG. 12 is a schematic front elevation view of the transfer of a load unit from the sector of FIG. 13 to a railcar;

FIG. 13 is a more detailed perspective view of a sector that constitutes the transfer lanes and of a railcar, according to A further aspect of the invention;

FIG. 14 is a front elevation view that illustrates schematically the transfer of a load unit from the sector of FIG. 13 to a railcar;

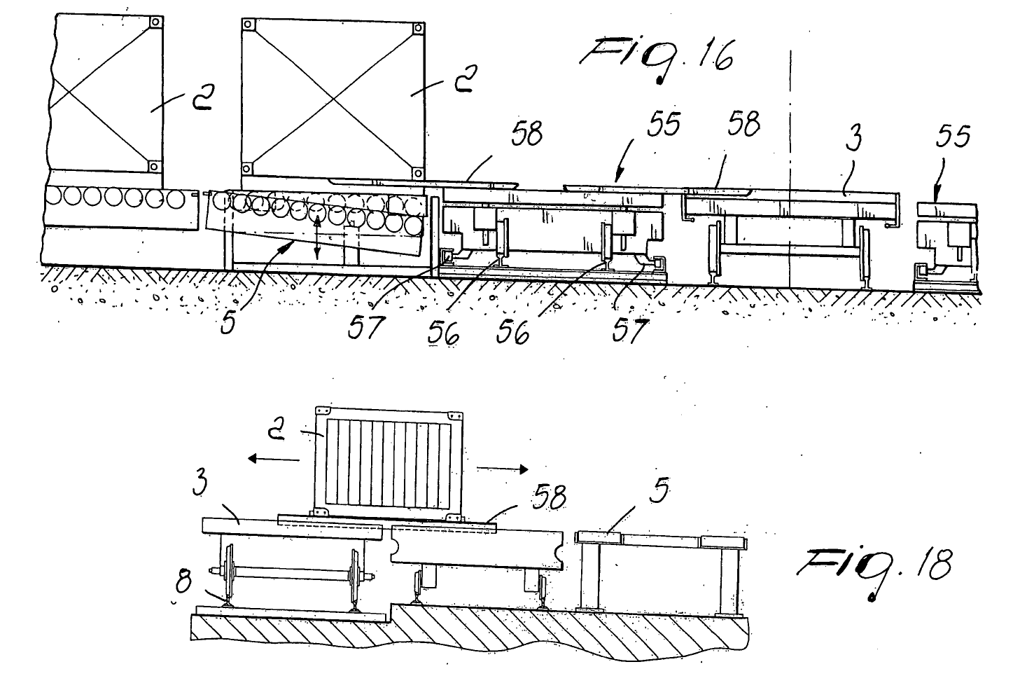

FIG. 15 is a top plan view of a sector constituting the transfer lanes and of a railcar, according to a further aspect of the invention;

FIG. 16 is a front view of the sector and railcar of the previous figures;

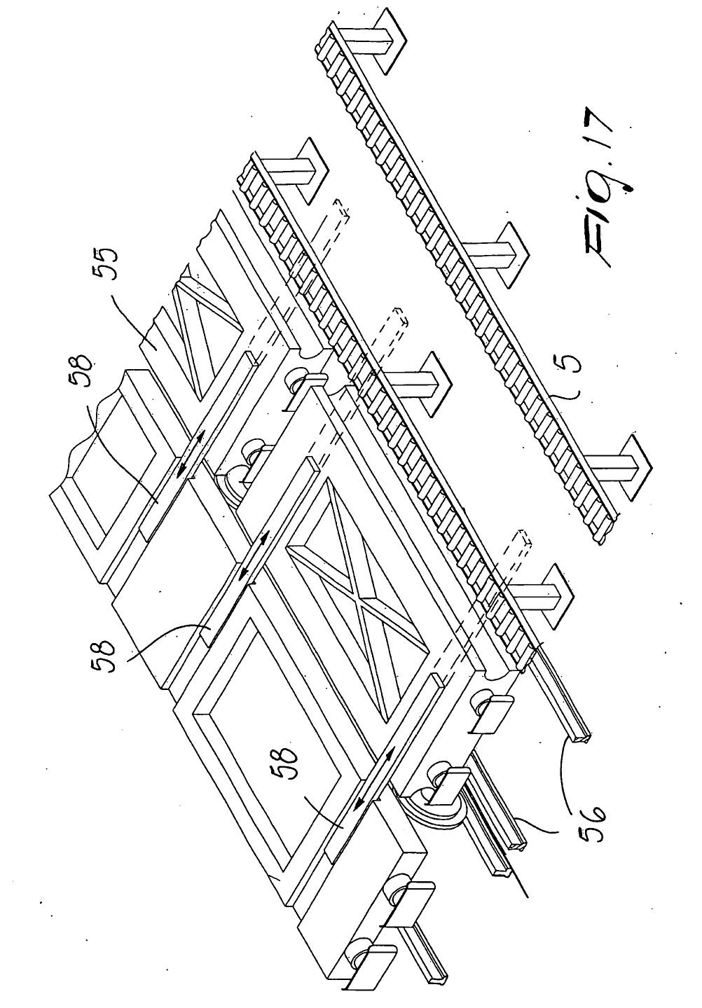

FIG. 17 is a perspective view of the sector shown in FIGS. 15 and 16;

FIG. 18 is a front elevation view that illustrates schematically the transfer of a load unit from the sector of FIGS. 15-17 to a railcar.

The method according to the invention essentially comprises the following steps: a first transport by truck to the nearest station equipped with a specialized terminal, generally designated by the reference numeral 1 in the FIG.s; placing the load unit 2 on the ground or on a transfer system 4, which in turn feeds an automated loading platform 5 which by means of servo-assisted remote-controlled systems loads the load unit onto a railcar 3 with horizontal transfer systems described in detail hereinafter.

It is possible to work with the same system also by feeding the loading platform with a load-moving machine.

At the stations where various routes intersect, switching between one train and another occurs, always with high-capacity and highly automated transfer systems, until the load unit 2 arrives at the last station equipped with a specialized terminal, where the freight company stores it on the ground or in an automated storage facility with roller conveyors or similar devices, described in greater detail hereinafter, and where unloading from the railcar again occurs by means of a horizontal transfer system.

After a parking time of a few minutes or hours, the load unit 2 is loaded, by means of a crane, generally designated by the reference numeral 6, or lift trucks, onto a truck 7, which delivers it.

The system according to the invention allows to transfer cargo from trains to trucks as well as to ships or to another train system.

In case of transfer to a ship, the storage system may be easily used also to complete the stowage in the ship itself making good use of the method of horizontal transfer by means of modules 5, provided with motorized belts, rollers, wheels, chains, or pallet forks.

The system according to the invention may also be used for transferring cargo from one train system to a different train system or between trains.

The system uses standard modular load units, i.e., 20- to 40-foot containers, and all the variations, preferably provided with ISO couplings, and the like, and adapted for loading on intermodal railcars.

The organization of the transport system includes trains at regular time intervals on a fixed route, with a fixed composition, with predefined stops at a distance of approximately 100-200 km from each other, in stations or terminals in industrial areas, and longer legs if the region being crossed is not interesting in terms of traffic.

The stations are preferably chosen according to the following parameters: position with respect to inhabited areas; space availability; good road and highway links; proximity of branches leading to various main railroad routes.

The method can operate with terminals of different complexity and size; for example, there are three types of terminal: head terminals, single-track transit and delivery terminals, and transit and delivery terminals with multiple work tracks, of the type shown in the figures.

The terminals can also operate with only part of the provided infrastructure; in particular, the storage system can be avoided.

The terminal 1 is based on a method of horizontal transfer by means of modules 5, provided with motorized belts, rollers, wheels, chains, or pallet forks, which are mutually isolated but act as a single system; in particular, there are two kinds of module: a module that allows bi-directional transfers on a single axis and a module that allows bi-directional transfers along two mutually perpendicular axes.

Some concatenations of modules are adapted to move the load units 2, others are specialized for storage; others still are adapted to allow loading/unloading onto/from the railcar.

The terminal 1 therefore comprises a means 5 adapted for bidirectional and perpendicular transfer, which is mounted parallel to the track, so as to receive or place, on the railcar 3, the individual load units 2, both individually and simultaneously on multiple railcars.

In particular, in the single-track terminal, provided in order to accommodate long trains, a single train at a time is active and is provided with a sufficiently long sidetrack, from which a dead-end track for switching operations also branches off.

The track, designated by the reference numeral 8, with particular reference to FIGS. 3 to 5, is preferably arranged in a trench 9 and is provided laterally with two transfer lanes 5, one for each side: the first lane, on the yard side, is adapted for loading, while the second path, on the track side, is adapted for unloading.

The two transfer lanes can be mutually connected, when the train is not present, by means of a lifting transfer lane, which is not shown in the figures.

Parallel to the transfer lane, on the yard side, it is possible to arrange a deposition platform, generally designated by the reference numeral 4, which is capable of moving automatically the load units 2 or of transferring them, again horizontally, to the transfer path 5 that is adapted to feed the truck loading area, or the loading area of any other type of transport, which is provided with a self-propelled unit or gantry crane 6, as shown in the example given in the figures, with reference to a truck transport system.

The same system of transfer paths can be used to receive the load units that have arrived at the terminal by truck, or any other transport system, and are placed, again by means of the self-propelled unit or gantry crane, on the receiving line.

The load unit is thus positioned in storage on the region preset for a given destination and is then transferred onto the lane intended for loading and then loaded onto the railcar in a predefined position.

A similar system operates on the transfer lane for unloading, which is cleared after each train has left.

When a load unit must be transferred onto a subsequent train, it is stored temporarily in the most useful position for subsequent pick-up.

In economic terms, the transfer lane can act only on a sector of the train, or on its entire length, depending on the volumes to be moved along half or one third of the length.

In stations with low volumes, the storage and unloading system can be replaced with a self-propelled vehicle that loads and unloads the trucks and also feeds the railcar loading lanes.

In this case, the frequency with which the trains arrive includes longer intervals, such as to ensure the unloading of the receiving line and the loading of the feed line. To work in the optimum manner, it is necessary to use railcars that are preferably identical and in locked compositions.

The double-track terminal, of the type shown in the figures, allows to work with two trains present at the same time and is useful especially for unloading from one train and reloading onto another one in extremely limited times, on the order of a few minutes.

In this case, each one of the two tracks has, on both sides, a transfer line 5 and an automated storage system not smaller than 80 40-foot load units or 160 20-foot load units, or even in mixed form.

Each of the two transfer lanes is provided with a connection system that can be lifted in the absence of trains at the loading area.

The transfer lanes comprises independent sectors 5, which are arranged longitudinally at a preset distance from each other and can be actuated independently and sequentially with respect to each other until the load unit 2 is finally positioned.

It is possible to provide sectors of different length, depending on whether one wishes to act separately on each individual container or in pairs.

When a load unit is of the shorter type, it affects a single sector 5; when it is longer, it affects two sectors simultaneously, depending on the length of the sectors.

The sectors that cause the bi-directional advancement or retraction of one unit can comprise various transfer and support means according to the requirements.

For example, FIGS. 7-10 illustrate a sector 5 comprising two roller conveyors 10 that are adapted to make the load units 2 advance easily. The load units 2 are provided with positioning blocks, for example of the so-called twist-lock type, that protrude from the rest of the platform.

The rollers, which can also be replaced with motorized chains, are arranged so as to work under the lateral parts of the load units 2 or with wheels combined with surfaces provided with free ball bearings; in this case, the container must be placed on a surface that is adapted to allow movement on the entire system.

To ensure that the load units 2 advance centrally along the conveyors, the conveyors can be provided with side bumpers with free rollers or with another guiding and orientation system.

The central part of the roller conveyor can be lightened by means of a stiffening structure.

Each sector 5 is preferably provided with independent electric motors, which are activated automatically as the load unit 2 approaches and are deactivated as soon as the unit has passed.

The operation of the automatic load unit positioning system is controlled by an integrated system of photocells and television cameras.

The sectors must produce the transverse advancement or retraction of the load units 2, and for this purpose are provided in the central part with two belt members 11 or with wheels associated with free ball bearings.

The belt members 11 are provided with a lifting system having a preset stroke and can operate in both directions of travel, allowing to move the overlying load unit 2 to the right or to the left.

The two belt or wheel members always operate together and, if they have to move a long load unit, move simultaneously with the belt members of the contiguous sector.

The sectors 5 intended for the advancement and loading of the railcars 3 are provided with a combined system of rollers 10 for longitudinal movement and of belt members 11 for transverse movement. Both movements are controlled by photocell systems, which activate and deactivate operation and ensure the centering of the load units.

In particular cases, a structure, such as a plate, made of steel, or other adapted material, is interposed below the load unit in order to facilitate its movement in the terminal; the plate is provided so as to leave free the regions proximate to the twist-lock units. The twist-lock may be used as an extra locking means.

In this case, the plate may follow the load unit along its entire path both in the terminal and on the train up to the destination terminal, or may stay within the terminal area. In this case, the terminal is provided with a plate accumulation and distribution system. The interposed plate simplifies the system considerably; in this case, the sectors can be provided by way of example as in FIGS. 11 and 13 or FIGS. 15 and 17.

FIG. 11 shows in particular a system with two sets of rollers, designated by the reference numerals 12 and 13 respectively, which are arranged at right angles to each other and are motorized in order to move the load units both longitudinally and transversely.

At least one set of rollers can move vertically in order to engage or disengage the load unit.

FIG. 13 illustrates a similar system, which instead of having rollers is provided with two sets of wheels, designated by the reference numerals 14 and 15 respectively.

In these two last cases, the rollers or wheels allow advancement in the intended directions, while the weight is carried by a system of free ball bearings inserted in the frame of the module.

FIGS. 15 and 16 illustrate a further loading system characterized by moving sectors 55 instead of the standing sectors of the previously described systems.

One or more sectors 55 are movable along a side track 56 and automatically controlled by guide means 57.

Pallet-type forks 58 transfer the load units 2 from the trucks onto the standing loading/unloading sectors 5 and, from the standing sectors 5 onto the moving sectors 55 and finally onto the railcars 3.

The system illustrated in FIGS. 15 and 16 is more economic while still affording the essential advantages of the invention because each loading unit 2 may be loaded into the selected railcar by the moving sector 55 which may move from the loading position into the loading position next to the selected railcar 3.

As described above, the terminal can be organized by means of transfer lanes organized into sectors provided with motorized members of the belt, roller, chain, wheel or pallet type having a fixed or movable position, which can be lifted and are adapted to move the load units transversely and/or longitudinally.

The trucks 7 are preferably loaded by means of gantry cranes 6, but can also be loaded by means of self-propelled machines, or of the horizontal transfer system described above, which can also deposit on the ground load units that are not adapted for transport or must remain parked for a longer time.

Moreover, some units 2 are loaded onto semitrailers, which are delivered subsequently and therefore parked temporarily in the area of the terminal.

Container-carrying railcars are used, and it is important that the railcars are used always on the same lines and therefore preferably operate in the same equipped terminals, due to evident problems of centering with respect to the transfer sectors; in any case, if necessary, a train can be unloaded or loaded in a conventional intermodal terminal.

The railcars also have belt, chain, roller, or wheel members 11 that are adapted for lifting, with a preset stroke, so as to disengage the load unit and allow loading and unloading. The railcars may also be provided with means for allowing pallet forks to slide for transferring the containers.

Each sector with belts, chains, rollers, wheels or pallet forks is preferably provided with an independent electric motor, which operates by means of a power supply that is ensured when the train is motionless at the terminal, or there can be a ground-based mechanical actuation system that transmits motion also to the transfer system on the railcar; the system is deactivated at the end of the operation. The railcar is also provided with a system of abutments that are actuated electrically with compressed air and/or with springs in order to allow the centering of the load units on the safety retainers; these abutments also increase safety during transport, and the railcar also may have retractable lateral guides with automatic centering that are also adapted to facilitate the centering of the load.

The terminal can be provided with a system of television cameras to control its correct operation.

A similar television camera system can be installed on the railcars.

The described systems can be fitted on currently circulating railcars, but it would be preferable to provide the system with a fleet of railcars especially fitted for loading by lateral transfer.

The operation of the system according to the invention is as follows.

Every day, the operators of a terminal receive the orders related to the load units to be transported directly from the Head Office, which receives customer requests and accepts bookings for the individual train and for the intended final destination, routing the work load to the nearest or most convenient terminal depending on the space available on the train and on the load combinations.

The Head Office must always be up to date and must intervene promptly, notifying the customer regarding advances and delays. Preferably, the terminal handles, either directly or by means of contracted companies, road supply transport so as to optimize loading times and minimize the parking of the load units at the facility. In any case, the customer can handle directly the supply transport of the terminal, provided that delivery at the intended time is guaranteed.

Transport can use normal trailers or semitrailers for carrying containers. It is possible to provide some terminals with a self-loading means for delivering the load units, thus allowing the unloading of the load unit even without handling means. For this purpose it is possible to use semitrailers provided with small cranes at their ends or other similar systems, for example containers provided with a sliding system, or systems similar to those of the railcars.

The driver of the truck goes to the load at the customer after receiving, for example via e-mail, a transport note sent via computer to his headquarters or collected at the terminal.

Upon arrival at the terminal, the driver himself unloads the vehicle by means of a gantry or self-propelled crane; at the end of the operation, the driver applies an adhesive label with a bar code that allows to follow all the steps of transport and storage.

At this point, the load unit 2 is placed in the storage position already provided at the facility or on the ground, in any case so as to facilitate its return to circulation when intended. This operation is performed semiautomatically by the terminal operators.

In good time before the train for the intended destination arrives, the terminal operators move the load units that are adapted to be loaded onto the arriving train along the feed lanes, placing each load unit in front of the programmed loading position, which can be already empty when the train arrives or will be emptied in the station being considered. Positioning occurs by feeding first the ends of the loading lane and then the central part.

Correct programming allows to work, for each terminal, only on one part of the train; if necessary, with an advancement maneuver, it is possible to position another portion of the train at the loading area.

Upon arriving, the train advances slowly until it is close to the final position and is moved, if necessary, into the final position by means of an auxiliary traction system.

The train staff must at this point prepare the movement systems arranged on the railcars, which are thus ready for the unloading step; this operation is performed by ground personnel in the case of systems for transmitting motion from the module to the ground.

In this step, the systems for movement on the railcars modified for this purpose allow the disengagement and unloading of the load unit, releasing the twist-locks of the load units 2. Then the combined roller and chain system is actuated, allowing to move the load units horizontally.

Each predefined receiving station arranged frontally is activated automatically by means of photocells and facilitates unloading; monitoring and control are performed directly or by means of television cameras.

Once the unloading step has ended, the loading step begins by means of the lane located on the other side of the track, which again with a combined motion places the load units on the intended station, which in turn cooperates to the loading operation.

A system of abutments actuated electrically on the railcar allows to center the safety retainers adapted to retain the load units. At the end of the centering operation, the load unit is coupled and locked in its seat for safe transport.

After the necessary verification on the part of the train staff, the train can leave at the scheduled time. As soon as the train has cleared the track, the operation for clearing the load units left on the unloading lane begins. This operation is again performed semiautomatically, by concentrating the load units toward the region for connection to the storage area.

As mentioned, there are two connecting sectors with conveyors that can retract in the railway; when raised, they ensure the continuity of the system for the lateral movement of the units.

According to the requirements of delivery, the received units can be:
temporarily stored in the automated storage system;
reloaded into the railcars;
routed directly to loading;
stored on semitrailers or trailers;
sent to other types of transport;
stored on the ground for longer-term storage.

Clearly, it is preferable to limit storage to the minimum indispensable time.

The trucks may be loaded directly by the driver or by the personnel of the terminal if the driver is not authorized. In the case of load units adapted to continue by train on to a different destination, they are placed in the storage system or directly on the loading lane if the train that is to receive them is a train that directly follows or if this is allowed by the operating conditions of the terminal.

At each processed train, the terminal personnel updates the loading plan of the train, which can be viewed by the personnel of the terminals that will be involved subsequently.

The operating model is based on a concept of functional simplicity and coordination simplicity, assuming the transport of a percentage of the goods that currently do not travel by rail because the load unit is the semitrailer, because for such transports the returns are incompatible with the use of the goods, and because rail charges are high owing to the high operating costs of the current system.

Clearly, a streamlined and efficient operating model reduces costs significantly and it is therefore fundamental that the operating model of the system be extremely simple: in particular, it is based on:
a head office that communicates with its customers via structured e-mails that directly feed the information system;
a central commercial office, which activates open contracts with all the customers involved; the contracts can provide charges by load unit and according to destination, with or without road collection and/or delivery;
terminal operators, who are responsible for picking up and delivering the load unit by truck and for correctly running the terminal;
a central system control, which follows the trains, controls their activity, schedules the activity of the personnel and works in close contact with the head office;
a maintenance sector, which maintains the terminals directly or by means of third parties.

The trains are followed, along their route, by means of satellite tracking systems.

The efficiency of the system is based on an information system that controls:
compliance with the train dispatching schedule;
the position of the load units;
the cycle of the load unit in the terminals;
compliance with delivery times.

The customers, via the Internet, can know, optionally after checking their clearance by means of a password, where their goods are and when their delivery is expected.

In practice it has been found that the invention achieves the intended aim and objects, a system having been provided in which the disengagement of the goods from the railcar is performed by using the railcar as a support for transport but not as an enclosure for containing the goods, trying to liken the load unit to a passenger who arrives at the station, gets on the first train, gets off very simply and cheaply, takes connecting trains to the destination station and reaches his final destination with another means of transport.

The “seat occupied” on the train, and therefore on the railcar, is occupied only for the time of transport, without particular uneconomical aspects and system complexities.

The proposed solution allows to pick up and deliver any multiple of the minimum load unit, which in the illustrated example is approximately 30 m³ 60/80 m³ with a weight of approximately 20-30 t, from any geographical location with a predefined, assured and modest return time and at a definitely lower cost than current rail transport systems.

The terminal can also be used as a concentration point for smaller batches, which can be loaded together on a load unit for a predefined destination. In this case, the terminal can act as a delivery point or deliver the goods to destination by truck, by means of small road vehicles or by contracts with couriers that are already present in the distribution area.

By analyzing the direct and system costs, it is evident that the market price offer is competitive with respect to the main competitor, which is currently constituted by a truck transporting directly from start to destination.

The system may be used in port areas for transferring cargo to a train system rather than trucks as currently happens.

This distribution system can be particularly useful for shipping perishable goods, live animals and refrigerated containers, in view of the low return time and of the assistance that can be provided by the personnel working at the terminals.

It is to be expected that the users of such a system, which fits perfectly the concept of intermodal transport, will increasingly benefit from subsidies useful to promote diffusion of the system.

It should be noted that the trains will have empty spaces, i.e., spaces not occupied by load units. Such empty spaces are natural and indeed allow to handle any urgent assignments or to cope with unexpected problems, such as strikes, line stoppages, et cetera.

The presence of empty spaces does not cause a problem of insufficient loading or insufficient utilization of the railcars, which in any case are recovered due to the reduction in the cycle time of the railcar. With experience, it is also possible to create a system of charges that rewards those who schedule transport in advance, thus allowing better programming of work; moreover, since transport occurs by means of load units, transports must be balanced also due to the transport of the empty containers in some cases.

In case of use of plates, or base plates, on which the load units are placed, it is necessary to provide returns, again on a railcar, of multiple panels in order to realign the inventory of the individual terminals.

As regards the containers or load units, they can belong to the freight and transport companies, which deal directly with the logistics; as regards the containers, it is believed that in view of the wide use of this transport system derived from seagoing transport, there is already sufficient availability in the normal rotation; indeed, some containers might thus return to the vicinity of their port of origin loaded instead of empty.

As regards the availability of necessary surfaces in stations, it should be noted that goods freight is privileging intermodal centers, large industrial facilities and ports; therefore, spaces that are certainly sufficient for the intended purpose are gradually becoming available. Moreover, it should be noted that it is possible to use secondary stations and/or activate new installations proximate to them.

The system according to the invention can also be activated on individual lines with a low transport frequency; moreover, the train can also be routed onto secondary lines without particular problems.

One innovation of the method and apparatus according to the invention is the system of loading and unloading lanes that are parallel to the track, which allow to unload and load an entire train in a short time and most of all to transfer from one train to another in real time.

A further advantage is the possibility to work on electrified tracks without particular operating limitations. So far, designs related to loading and unloading a single carriage at a time, without a systems logic, have been developed.

A further innovation of the method is the provision of a flexible network system that is independent of the need to work in dedicated terminals and with a system of regularly scheduled trains that cross and therefore allow to transport the load unit anywhere.

Bearing in mind that the railroad system is even today organized with the same operating criteria established at its birth and therefore there is certainly space for new operating methods, the method according to the invention, both in the functional organization of the terminals and in the operating modes of the system, concretely solves many of the problems that constrain the use of the train for “door-to-door” transport.

The system according to the invention may also be used for transferring goods from docked ships into trains and viceversa, from shuttle trains into regular trains, from trains into satellite transport means, such as for example so called “light trains” used within city limits. In general the method and the apparatus according to the invention are useful for transferring standard containers, or any other loading unit, from any means of transportation to another means of transportation.

The method and the apparatus according to the invention are susceptible of numerous modifications and variations, within the scope of the appended claims. All the details may be replaced with technically equivalent elements.

The materials used, as well as the dimensions, may vary according to the requirements and the state of the art.

1-44. (canceled)

45. A method for mixed transport by train and other means of transportation, characterized in that it comprises the steps of:
placing a load unit that arrives from a means of transportation in a holding position in an initial rail terminal;
taking said load unit from said holding position and moving it to a loading and unloading position that is adjacent to a track preset for the parking and operation of a train;
transferring said load unit from said loading position to said train;
in a destination terminal, transferring said load unit from said train to a position for loading and unloading in said terminal;
removing said load unit from said loading and unloading position and arranging it in said holding position;
removing said load unit from said holding position and placing it in said loading and unloading position, in order to transfer said load unit onto a new train or said means of transportation;
wherein the movements of said load unit are managed and monitored by a software system;
wherein said load unit is selected from the group consisting of ISO standard containers, swap bodies, palletized cargo and non-standard commercial containers;
wherein said holding position being adjacent to said loading and unloading position; and
wherein said load unit being moved by horizontal translational motion and combined vertical and horizontal translational motion.

46. An apparatus for loading and unloading a load unit from a train, comprising:
a means for the horizontal translational motion and combined horizontal and vertical translational motion of said load unit, which is adapted to transfer said load unit from a means of transportation to said train, said translational motion means includes at least one transfer lane that is arranged along one side of a track which is adapted to transfer said load unit from said transfer lane to a loading platform of a railcar of said train that is waiting on said track and from said platform of said railcar to said transfer lane; and
a deposition platform arranged parallel to said transfer lane, said deposition platform being adapted to automatically transfer said load unit from said transfer lane to said loading platform of said railcars, and to unload said load unit from said loading platform of said railcar to said transfer lane.

47. The apparatus as of claim 46, wherein said horizontal and combined vertical and horizontal translational motion means comprises at least two transfer lanes, one for each side of said track, said transfer lanes including a first transfer lane being adapted for loading and a second transfer lane on the track side being adapted for unloading.

48. The apparatus as of claim 47, wherein said transfer lanes are mutually connected, when said train is not present, by means of a transfer lane that can be extended.

49. The apparatus as of claim 46 further comprising a load unit transfer system for loading and unloading said load unit from said means of transportation.

50. The apparatus as of claim 46, wherein said deposition platform being capable of longitudinal movement with fine adjustment to precisely meet the position of said railcar, said deposition platform being capable of advancing said load unit in a translational motion transverse to said tracks and a vertical motion.

51. The apparatus as of claim 46, wherein each transfer lane comprises independent sectors, said independent sectors being arranged longitudinally at a preset distance from each other and can be actuated independently and sequentially with respect to each other until the final positioning of said load unit is achieved.

52. The apparatus as of claim 51, wherein each one of said sectors comprises two lanes, said lanes having a load unit advancement mechanism.

53. The apparatus as of claim 52, wherein said load unit advancement mechanism being arranged to act under said load unit, said load unit advancement mechanism is selecting from the group consisting of belts, rollers, motorized chains, wheels and pallet forks.

54. The apparatus as of claim 51 further comprising a second set of lanes arranged at right angles to said first lanes, said second set of lanes having a load unit advancement mechanism, said load unit advancement mechanisms of said first and second lanes are adapted for moving said load unit both longitudinally and transversely.

55. The apparatus as of claim 54, wherein said load unit advancement mechanism comprises a lifting system for raising said load unit advancement mechanism up to contact said overlying load unit for moving said load unit to the right and to the left.

56. The apparatus as of claim 54, wherein each of said load unit advancement mechanisms are provided with at least one independent electric motor, said independent electric motor being controlled by an automatic system which activates when the load unit approaches and are deactivated as soon as the unit has moved past.

57. The apparatus as of claim 56, wherein said automatic system being selected from the group consisting of optical sensors, cameras, photocells, magnetic sensors, and GPS systems.

58. The apparatus as of claim 46, wherein said load unit having at least one positioning block.

59. The apparatus as of claim 46 further comprising a guiding system for said load unit.

60. The apparatus as of claim 59, wherein said guiding system is at least one side bumper having at least one free wheel.

61. The apparatus as of claim 46 further comprising a base plate interposed under said load unit in order to facilitate its movement, said base plate is adapted to be confined in said apparatus and accompanying said load unit aboard said railcar and said means of transportation.

62. The apparatus as of claim 46, wherein said railcars of said train having a load unit advancement mechanism, said load unit advancement mechanism comprises a lifting system for raising and lowering said load unit advancement mechanism to engage and disengage said overlying load unit thereby allowing both loading and unloading of said load unit from said railcar.

63. The apparatus as of claim 46, wherein said railcar further comprises a system of movable abutments and retractable lateral guides for facilitating the centering of said load unit on said railcar.

64. The apparatus as of claim 46, where said railcar further comprises a locking system, said locking system of said railcar being adapted to act on said load unit when loaded directly onto said railcar.

65. The apparatus as of claim 50, wherein said sector comprises at least one line of standing sectors adapted to load and unload said load unit from said vehicle, and at least one line of moving sectors positioned between said line of standing sectors and said track, said moving sectors being adapted to receive said load unit from said standing sector and to load said load unit to said railcar in a selected position along said track, said moving sectors being adapted to receive said load unit from said railcar in a selected position along said track and to load said load unit onto said selected standing sector.
